(19) United States
(12) Patent Application Publication
(10) Pub. No.: US 2025/0104581 A1
(43) Pub. Date: Mar. 27, 2025

(54) BRIGHTNESS AND POWER EFFICIENCY IN AUGMENTED REALITY (AR) DISPLAY DEVICES

(71) Applicant: Meta Platforms Technologies, LLC, Menlo Park, CA (US)

(72) Inventors: Ajit NINAN, San Jose, CA (US); Thomas Scott MURDISON, Seattle, WA (US); Romain BACHY, Seattle, WA (US); Ian ERKELENS, Kirkland, WA (US)

(73) Assignee: Meta Platforms Technologies, LLC, Menlo Park, CA (US)

(21) Appl. No.: 18/475,854

(22) Filed: Sep. 27, 2023

(51) Int. Cl. G09G 3/00; G06F 3/01

(52) U.S. Cl. CPC G09G 3/002; G06F 3/012; G06F 3/013; G09G 2320/0626; G09G 2340/0435; G09G 2354/00; G09G 2360/144

(57) ABSTRACT

Techniques for enhancing brightness and power efficiency in augmented reality (AR) display devices are described. To enhance brightness and power efficiency a near-eye display device's duty cycle may be adjusted based on a type of usage (e.g., world-locked or head-locked); a persistence or a display rate may be varied based on head movement speed; the brightness may be adjusted based on sensed ambient light; ambient brightness may be matched by utilizing camera-based scene understanding determining a user's gaze direction and then decreasing brightness of the gaze's peripheral; the display brightness may be controlled based on gaze and/or eye motion; and/or if the user is moving, world-locked rendering (WLR) targets and/or refresh rates may be altered, or WLR varied for peripheral content based on a comparison of gaze direction and a virtual object location.

### TECHNICAL FIELD

First section of this patent application relates generally to near-eye display devices, and in particular, improvement of display brightness and power efficiency in augmented reality (AR) near-eye display devices.

Second section of this patent application relates generally to augmented reality (AR)/virtual reality (VR) content presentation, and in particular, making available objects discoverable without permission granting process.

Third section of this patent application relates generally to camera devices, and in particular, a bifocal mixed reality pass-through camera with partial imaging areas focused at different distances.

Fourth section of this patent application relates to a scanning system for eye tracking applications, and in particular, to a scanning system that employs a dynamic photodiode (DPD).

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment. Head-mounted display (HMD) devices may also present interactive content, where a user's (wearer's) gaze may be used as input for the interactive content.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display device, according to an example.

FIGS. 2A-2C illustrate various views of a near-eye display device in the form of a head-mounted display (HMD) device, according to examples.

FIGS. 3A and 3B illustrate a perspective view and a top view of a near-eye display device in the form of a pair of glasses, according to an example.

FIGS. 4A-4E illustrate various techniques to adjust display brightness and/or power efficiency in an augmented reality (AR) near-eye display device, according to examples.

FIG. 5 illustrates a flow diagram for a method of adjusting display brightness and/or power efficiency in an augmented reality (AR) near-eye display device, according to some examples.

FIGS. 6 to 9 illustrate aspects concerning Section II-Discovery and Engagement of Virtual Reality Content Through Late-Binding of Permissions, of the present disclosure.

FIGS. 10 to 15 illustrate aspects concerning Section III-Bifocal Dynamic Camera Framing for Near-Eye Display Devices, of the present disclosure.

FIGS. 16 to 19 illustrate aspects concerning Section IV-A Dynamic Photodiode For Lower Power Consumption High Dynamic Range Eye Tracking, of the present disclosure.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

In near-eye display devices, display power consumption usually includes driving (e.g., display driver integrated circuit “DDIC” on a display module), optical emission (backlight or light emitting diode (LED) light source), and computation (processor). There are many factors influencing power consumption in optical emission including content dependency. For example, a microLED display may consume more power when black text is presented on white background as opposed to white text on black background. Other operational modes of the near-eye display device may also impact power consumption, which is a critical design and operation parameter in battery-driven near-eye display devices.

The present disclosure describes techniques for enhancing brightness and power efficiency in augmented reality (AR) display devices. To enhance brightness and power efficiency a near-eye display device's duty cycle may be adjusted based on a type of usage (e.g., world-locked or head-locked); a persistence or a display rate may be varied based on head movement speed; the brightness may be adjusted based on sensed ambient light; ambient brightness may be matched by utilizing camera-based scene understanding determining a user's gaze direction and then decreasing brightness of the gaze's peripheral; the display brightness may be controlled based on gaze and/or eye motion; and/or if the user is moving, world-locked rendering (WLR) targets and/or refresh rates may be altered, or WLR varied for peripheral content based on a comparison of gaze direction and a virtual object location.

While some advantages and benefits of the present disclosure are apparent, other advantages and benefits may include increased accuracy and quality of displayed content along with reduced power consumption.

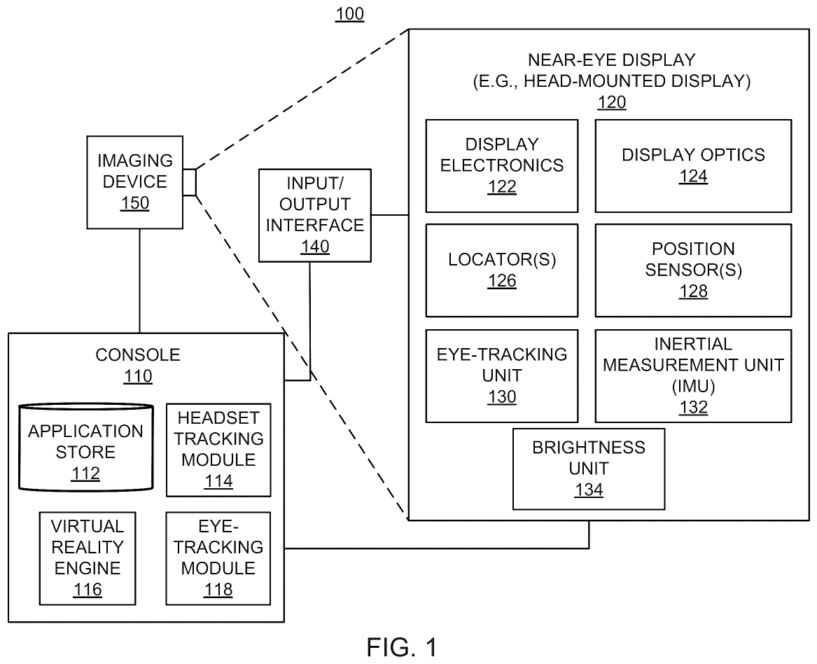

FIG. 1 illustrates a block diagram of an artificial reality system environment 100 including a near-eye display device, according to an example. As used herein, a “near-eye display device” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display device.”

As shown in FIG. 1, the artificial reality system environment 100 may include a near-eye display device 120, an optional external imaging device 150, and an optional input/output interface 140, each of which may be coupled to a console 110. The console 110 may be optional in some instances as the functions of the console 110 may be integrated into the near-eye display device 120. In some examples, the near-eye display device 120 may be a head-mounted display (HMD) that presents content to a user.

In some instances, for a near-eye display device, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display device, light from a surrounding environment may traverse a “see-through” region of a waveguide display (e.g., a transparent substrate) to reach a user's eyes. For example, in a near-eye display device, light of projected images may be coupled into a transparent substrate of a waveguide, propagate within the waveguide, and be coupled or directed out of the waveguide at one or more locations to replicate exit pupils and expand the eye box.

In some examples, the near-eye display device 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

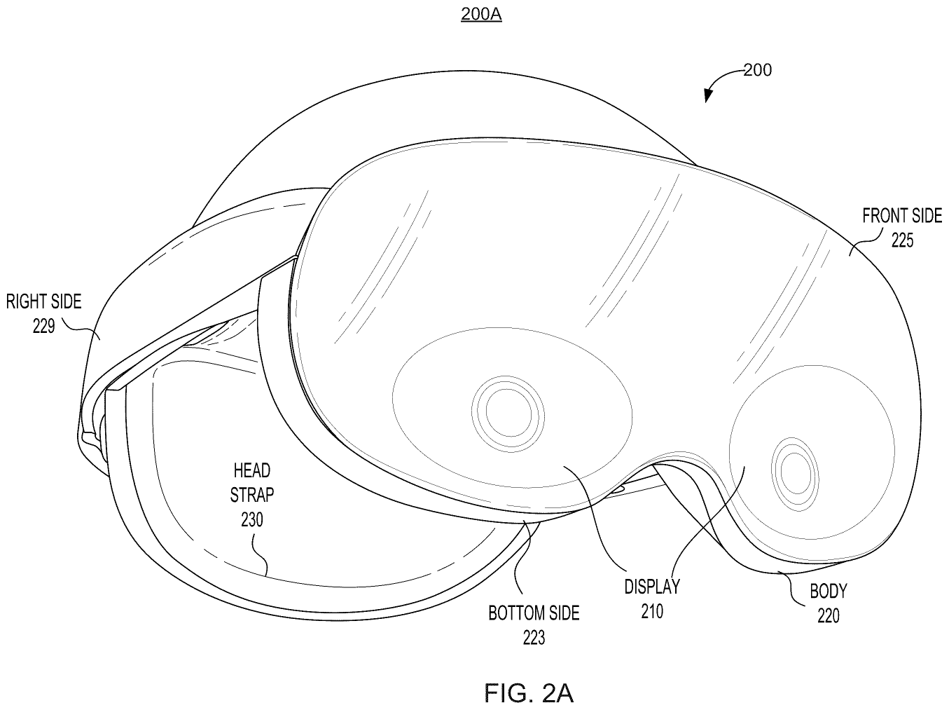

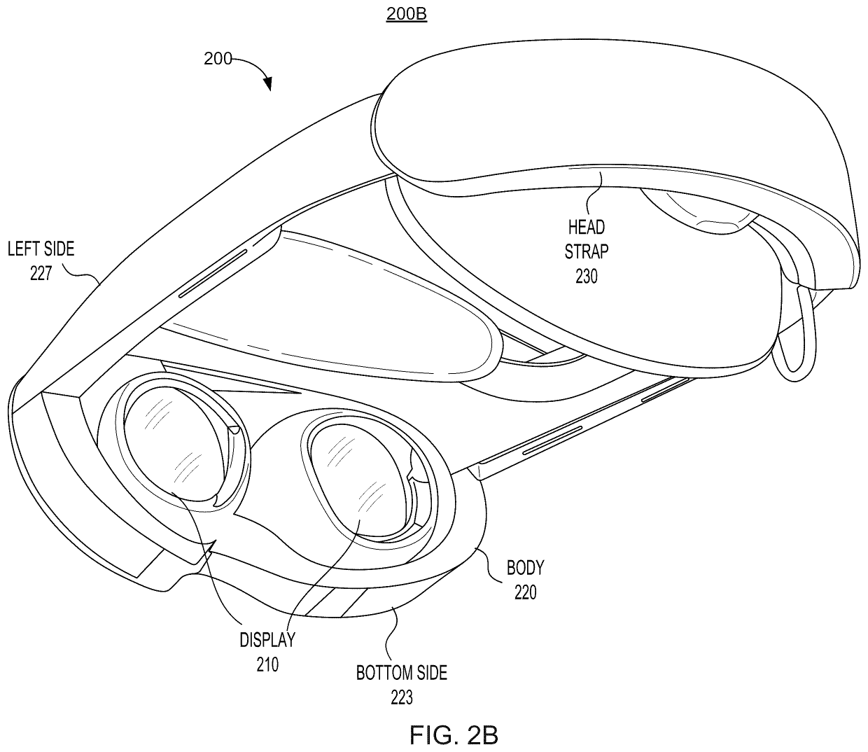

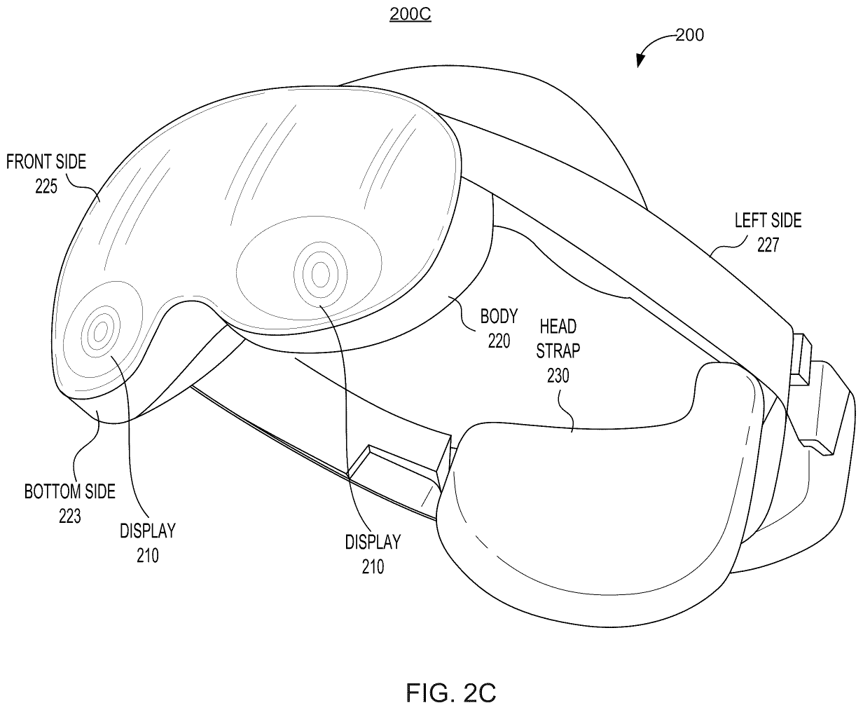

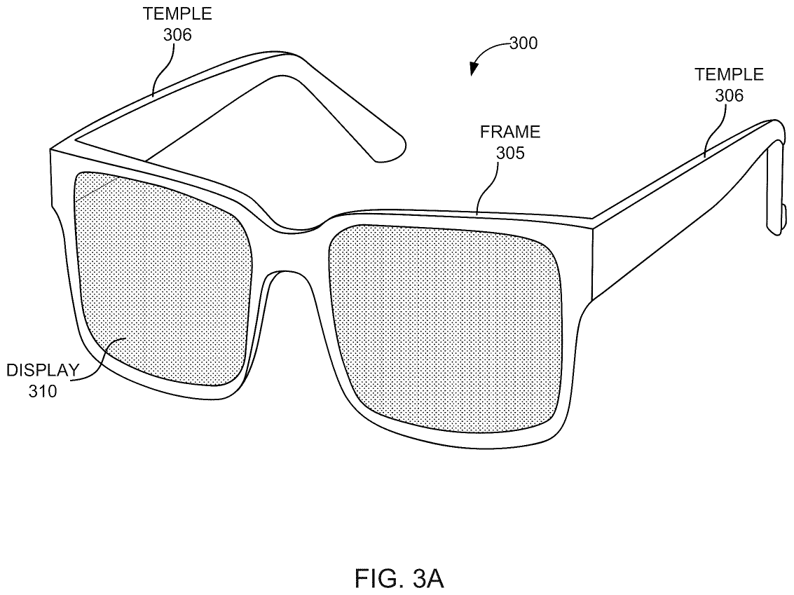

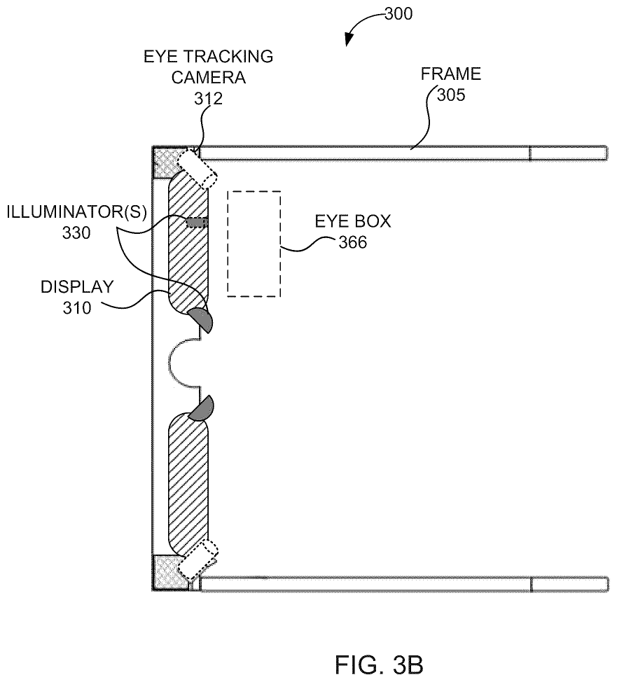

In some examples, the near-eye display device 120 may be implemented in any suitable form-factor, including a head-mounted display (HMD), a pair of glasses, or other similar wearable eyewear or device. Examples of the near-eye display device 120 are further described below with respect to FIGS. 2A-2C and 3A-3B. Additionally, in some examples, the functionality described herein may be used in a head-mounted display (HMD) or headset that may combine images of an environment external to the near-eye display device 120 and artificial reality content (e.g., computer-generated images). Therefore, in some examples, the near-eye display device 120 may augment images of a physical, real-world environment external to the near-eye display device 120 with generated and/or overlaid digital content (e.g., images, video, sound, etc.) to present an augmented reality to a user.

In some examples, the near-eye display device 120 may include any number of display electronics 122, display optics 124, and an eye tracking unit 130. In some examples, the near-eye display device 120 may also include one or more locators 126, one or more position sensors 128, and an inertial measurement unit (IMU) 132. In some examples, the near-eye display device 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, brightness and power efficiency of the near-eye display device 120 may be enhanced through a variety of techniques such as adjustment of duty cycle based on a type of usage (e.g., world-locked or head-locked); variation of a persistence or a display rate based on head movement speed; adjustment of the brightness based on sensed ambient light; matching of ambient brightness by utilizing camera-based scene understanding determining a user's gaze direction and then decreasing brightness of the gaze's peripheral; controlling the display brightness based on gaze and/or eye motion; and/or detecting if the user is moving and then reducing world-locked rendering (WLR) targets, and/or refresh rates, or varying WLR for peripheral content based on a comparison of gaze direction and a virtual object location. These actions may be managed by the brightness unit 134 in coordination with other modules and units in the near-eye display device 120 and/or the console 110.

In some examples, the near-eye display device 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display device 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display device 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display device 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display device 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display device 120 that may be relative to an initial position of the near-eye display device 120. For example, the inertial measurement unit (IMU) 132 may integrate measurement signals received from accelerometers over time to estimate a velocity vector and integrate the velocity vector over time to determine an estimated position of a reference point on the near-eye display device 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern) that is directed to an eye such that light reflected by the eye may be captured by the imaging system (e.g., a camera). In other examples, the eye tracking unit 130 may capture reflected radio waves emitted by a miniature radar unit, or electrical signals from the musculature surrounding the eyeballs. These data associated with the eye may be used to determine or predict eye position, orientation, movement, location, pupil characteristics (e.g., diameter, area) and/or gaze.

In some examples, the near-eye display device 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display device 120 for presentation to the user in accordance with information received from one or more of external imaging device 150, the near-eye display device 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display device 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display device 120 using slow calibration information from the external imaging device 150. For example, the headset tracking module 114 may determine positions of a reference point of the near-eye display device 120 using observed locators from the slow calibration information and a model of the near-eye display device 120. Additionally, in some examples, the headset tracking module 114 may use portions of the fast calibration information, the slow calibration information, or any combination thereof, to predict a future location of the near-eye display device 120. In some examples, the headset tracking module 114 may provide the estimated or predicted future position of the near-eye display device 120 to the virtual reality engine 116.

In some examples, the virtual reality engine 116 may execute applications within the artificial reality system environment 100 and receive position information of the near-eye display device 120, acceleration information of the near-eye display device 120, velocity information of the near-eye display device 120, predicted future positions of the near-eye display device 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display device 120 for presentation to the user.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIGS. 2A-2C illustrate various views of a near-eye display device in the form of a head-mounted display (HMD) device 200, according to examples. In some examples, the head-mounted device (HMD) device 200 may be a part of a virtual reality (VR) system, an augmented reality (AR) system, a mixed reality (MR) system, another system that uses displays or wearables, or any combination thereof. As shown in diagram 200A of FIG. 2A, the head-mounted display (HMD) device 200 may include a body 220 and a head strap 230. The front perspective view of the head-mounted display (HMD) device 200 further shows a bottom side 223, a front side 225, and a right side 229 of the body 220. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components such as a display 210 to present a wearer augmented reality (AR)/virtual reality (VR) content and a camera to capture images or videos of the wearer's environment.

As shown in the bottom perspective view of diagram 200B of FIG. 2B, the display 210 may include one or more display assemblies and present, to a user (wearer), media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the user may interact with the presented images or videos through eye tracking sensors enclosed in the body 220 of the head-mounted display (HMD) device 200. The eye tracking sensors may also be used to adjust and improve quality of the presented content.

In some examples, brightness and power efficiency of the head-mounted display (HMD) device 200 may be enhanced through a variety of techniques such as adjustment of duty cycle based on a type of usage (e.g., world-locked or head-locked); variation of a persistence or a display rate based on head movement speed; adjustment of the brightness based on sensed ambient light; matching of ambient brightness by utilizing camera-based scene understanding determining a user's gaze direction and then decreasing brightness of the gaze's peripheral; controlling the display brightness based on gaze and/or eye motion; and/or detecting if the user is moving and then reducing world-locked rendering (WLR) targets, and/or refresh rates, or varying WLR for peripheral content based on a comparison of gaze direction and a virtual object location. These actions may be managed by a processor on the head-mounted display (HMD) device 200 (or in a communicatively coupled separate device) in coordination with other modules and units in the head-mounted display (HMD) device 200.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface for communicating with a console communicatively coupled to the head-mounted display (HMD) device 200 through wired or wireless means. In some examples, the head-mounted display (HMD) device 200 may include a virtual reality engine (not shown) that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine may be used for producing a signal (e.g., display instructions) to the display 210. In some examples, the head-mounted display (HMD) device 200 may include locators (not shown), which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

FIG. 3A is a perspective view of a near-eye display device 300 in the form of a pair of glasses (or other similar eyewear), according to an example. In some examples, the near-eye display device 300 may be a specific example of near-eye display device 120 of FIG. 1 and may be configured to operate as a virtual reality display, an augmented reality (AR) display, and/or a mixed reality (MR) display.

In some examples, the near-eye display device 300 may include a frame 305 and a display 310. In some examples, the display 310 may be configured to present media or other content to a user. In some examples, the display 310 may include display electronics and/or display optics, similar to components described with respect to FIGS. 1 and 2A-2C. For example, as described above with respect to the near-eye display device 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 210 may include a projector, or in place of the display 310 the near-eye display device 300 may include a projector.

In some examples, the near-eye display device 300 may further include various sensors on or within a frame 305. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display device, and/or to provide an interactive virtual reality (VR), augmented reality (AR), and/or mixed reality (MR) experience to a user of the near-eye display device 300. In some examples, the various sensors may also be used for stereoscopic imaging or other similar applications.

In some examples, the near-eye display device 300 may further include one or more illuminators to project light into a physical environment. The projected light may be associated with different frequency bands (e.g., visible light, infra-red light, ultra-violet light, etc.), and may serve various purposes. In some examples, the one or more illuminator(s) may be used as locators, such as the one or more locators 126 described above with respect to FIGS. 1 and 2A-2C.

In some examples, the near-eye display device 300 may also include a camera or other image capture unit. The camera, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications. The near-eye display device 300 may also include an eye tracking camera.

FIG. 3B is a top view of a near-eye display device 300 in the form of a pair of glasses (or other similar eyewear), according to an example. In some examples, the near-eye display device 300 may include a frame 305 having a form factor of a pair of eyeglasses. The frame 305 supports, for each eye: a display 310 to present content to an eye box 366, an eye tracking camera 312, and one or more illuminators 330. The illuminators 330 may be used for illuminating an eye box 366, as well as, for providing glint illumination to the eye. The display 310 may include a pupil-replicating waveguide to receive the fan of light beams and provide multiple laterally offset parallel copies of each beam of the fan of light beams, thereby extending a projected image over the eye box 366.

In some examples, the pupil-replicating waveguide may be transparent or translucent to enable the user to view the outside world together with the images projected into each eye and superimposed with the outside world view. The images projected into each eye may include objects disposed with a simulated parallax, so as to appear immersed into the real-world view.

The eye tracking camera 312 may be used to determine position and/or orientation of both eyes of the user. Once the position and orientation of the user's eyes are known, a gaze convergence distance and direction may be determined. The imagery displayed by the display 310 may be adjusted dynamically to account for the user's gaze, for a better fidelity of immersion of the user into the displayed augmented reality scenery, and/or to provide specific functions of interaction with the augmented reality. In operation, the illuminators 330 may illuminate the eyes at the corresponding eye boxes 366, to enable the eye tracking cameras to obtain the images of the eyes, as well as to provide reference reflections. The reflections (also referred to as “glints”) may function as reference points in the captured eye image, facilitating the eye gazing direction determination by determining position of the eye pupil images relative to the glints. To avoid distracting the user with illuminating light, the latter may be made invisible to the user. For example, infrared light may be used to illuminate the eye boxes 366.

In some examples, the image processing and eye position/orientation determination functions may be performed by a central controller, not shown, of the near-eye display device 300. The central controller may also provide control signals to the display 310 to generate the images to be displayed to the user, depending on the determined eye positions, eye orientations, gaze directions, eyes vergence, etc.

In some examples, brightness and power efficiency of the near-eye display device 300 may be enhanced through a variety of techniques such as adjustment of duty cycle based on a type of usage (e.g., world-locked or head-locked); variation of a persistence or a display rate based on head movement speed; adjustment of the brightness based on sensed ambient light; matching of ambient brightness by utilizing camera-based scene understanding determining a user's gaze direction and then decreasing brightness of the gaze's peripheral; controlling the display brightness based on gaze and/or eye motion; and/or detecting if the user is moving and then reducing world-locked rendering (WLR) targets, and/or refresh rates, or varying WLR for peripheral content based on a comparison of gaze direction and a virtual object location. These actions may be managed by a processor on the near-eye display device 300 (or in a communicatively coupled separate device) in coordination with other modules and units in the near-eye display device 300.

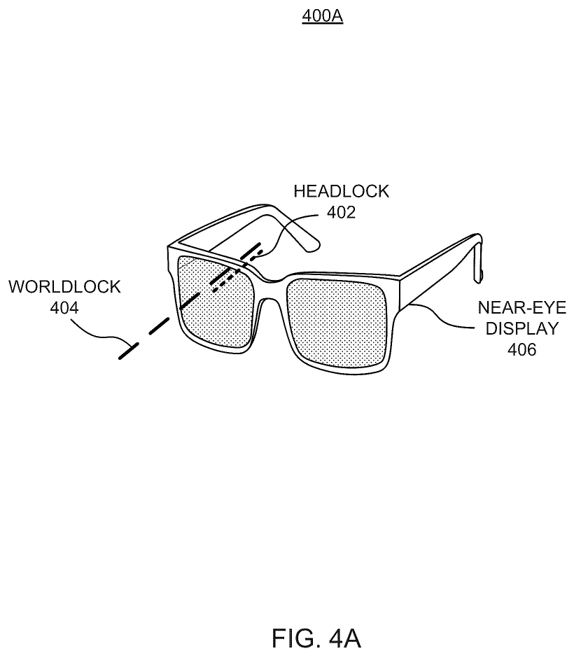

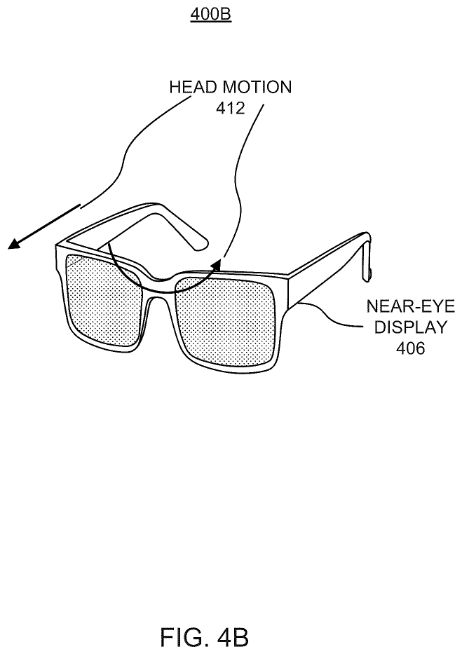

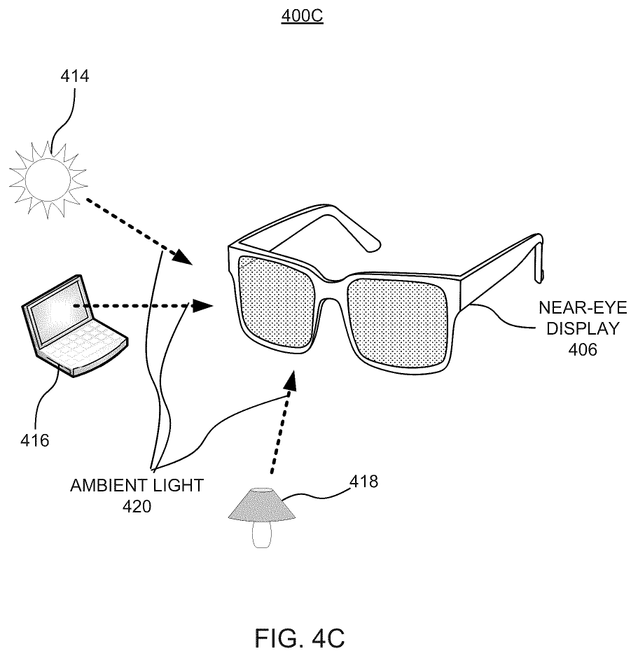

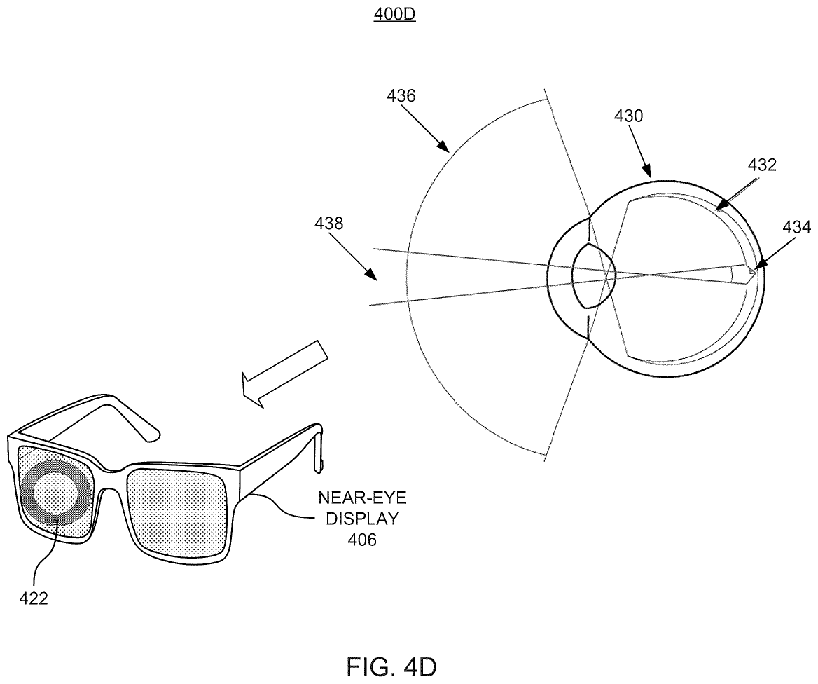

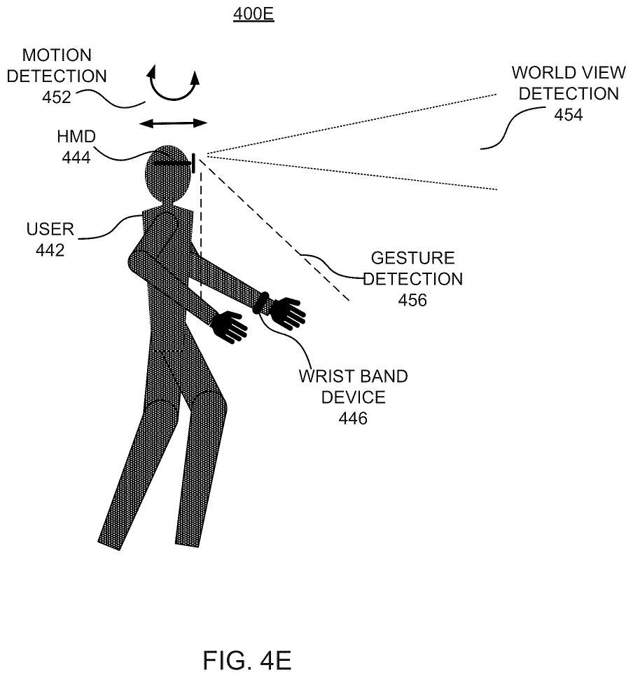

FIGS. 4A-4E illustrate various techniques to adjust display brightness and/or power efficiency in an augmented reality (AR) near-eye display device, according to examples.

Achieving adequate brightness in augmented reality (AR) displays is a major goal and challenge. Some implementations may be aiming for up to 500 cd/m², but display technology limitations, available power limitations on wearable devices, etc. may render actual implementations short of this goal. As mentioned herein, which portions of the consumed power are used by display driver circuitry and processing circuitry, optical emissions may consume a substantial part, which may be reduced without a reduction in brightness or brightness may be improved without corresponding power consumption increase according to some examples.

Diagram 400A in FIG. 4A shows two viewing scenarios in an augmented reality (AR) near-eye display device 406, a head-lock view 402 and a world-lock view 404. An augmented reality (AR) near-eye display device may include a see-through (transparent) display that allows the user to see their environment and/or displayed content.

In some examples, there may be two ways of presenting content in an augmented reality (AR) near-eye display device, a world-locked (static) view and a head-locked (following) view. In the world-locked view, the augmented reality (AR) content may be placed in a fixed position in the environment, and its position may not change with the user's movements. In this mode, the augmented reality (AR) system may recognize the user's environment to overlay the content, and the overlaid content may remain in the environment even if the user moves around. The world-locked (static) may be used as the default mode in augmented reality (AR) near-eye display devices. On the other hand, the head-locked (following) view may be more flexible and may be adjusted automatically based on the user's movements. In the head-locked mode, the augmented content may move based on the user's head movements and may be always in the user's field of view (FOV). In this mode, the position and rotation of the content presented to the user may change according to the camera motion. The content may always follow the user's head movement and stay at the same distance from the camera.

In some implementations, the content may need to be dynamically rendered as the head moves. Thus, a duty cycle of the display may be maintained very low, for example, 10% or lower. This may mean to achieve the same brightness as a phone display or tabletop monitor, the augmented reality (AR) display may need to be approximately ten times brighter. In such scenarios, the duty cycle may be adjusted dynamically based on head speed or based on the operation mode of either world-lock or head-lock. Thus, the duty cycle may be increased to 50% or even 100% in such scenarios leading to a brightness increase of 5 to 10 times from regular brightness. While the emission power may increase with the increase of the duty cycle, power consumption may be reduced by decreasing a frame rate (e.g., if the user is reading a book or a magazine).

Diagram 400B in FIG. 4B shows how some brightness and/or power consumption adjustments may be based on head motion 412 in the near-eye display device 406. In addition to the head movement based duty cycle adjustment discussed above, a persistence or display rate of the augmented reality (AR) display may also be varied based on head movement speed. A user with slower head movement speed may tolerate slower frame rate and higher persistence. In some implementations, the brightness may be increased by up to ten times depending on head movement speed. The persistence change does not cause a change in driving power, whereas the emission power varies with duty cycle change. The display rate change may vary driving power (with frame rate, for example a 30% reduction if frame rate is halved). The emission power may not change with the display rate.

Diagram 400C in FIG. 4C shows how display brightness and power consumption may be adjusted based on ambient light sensing. Ambient light may come from a variety of sources such as the sun 414, any device with a monitor (e.g., laptop 416), artificial light (e.g., lamps), etc. In the superimposition of the displayed content and the environment, if the ambient light is strong, the displayed content may need to be presented brighter to increase contrast between the two and make the displayed content more visible. In the reverse case, a brightness of the displayed content may be reduced. The ambient light level may be sensed by sensor(s) on the near-eye display device 406.

In some examples, camera-based scene understanding may be used to adjust brightness based on ambient light level. Similar to sensing based adjustment, a camera on the near-eye display device 406 may be employed. A camera may see a smaller field of view (FOV) (compared to the display FOV) and finer details to adjust the displayed content brightness in order to match ambient light levels.

Diagram 400D in FIG. 4D shows an eye 430 with a retina 432 and fovea 434. While the eye's vision range 436 (through the pupil) may be wide (e.g., 103 degrees), the actual focus range 438 based on the fovea is much smaller (e.g., a few degrees). Thus, the eye can see much more detail in the focus range 438 while the eye (and brain) ignores a substantive portion of details outside the foveal region. Therefore, in some implementations, a brightness profile 422 on the display of the near-eye display device 406 may be adjusted based on the user's gaze decreasing the brightness on the periphery (e.g., up to 40%).

In some examples, gaze or eye motion may be detected to determine if the eyes are looking at real world, and the augmented reality (AR) content may be dimmed or completely turned off. In some implementations, the overdrive may be a possible solution for the highlights near the gaze point.

In some examples, adaptive world-locked rendering may be employed. For example, if the user is detected to be not moving, world-locked rendering targets or refresh rates may be reduced. Further, gaze location may be determined with regard to displayed objects and world-locked rendering may be altered for peripheral content (reduce brightness for peripheral content).

Diagram 400E in FIG. 4E shows a user 442 wearing a head-mounted display (HMD) device 444, where brightness of display and/or power consumption may be adjusted based on motion detection 452 (head and/or body), world view detection 454 (vs. displayed content view), gesture detection 456, and/or an external device use (e.g., wrist band device 446). Gesture detection 456 and/or usage of the external device may be an indication of the user interacting with displayed content (as opposed to looking at the environment) and brightness may be adjusted based on that.

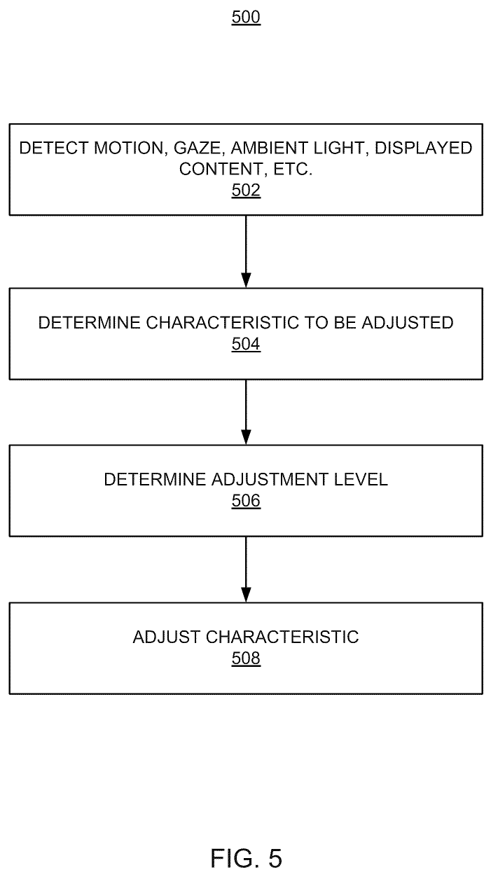

FIG. 5 illustrates a flow diagram for a method of adjusting display brightness and/or power efficiency in an augmented reality (AR) near-eye display device, according to some examples. The method 500 is provided by way of example, as there may be a variety of ways to carry out the method described herein. Although the method 500 is primarily described as being performed by the components of FIGS. 1, 2A-2C, 3A-3B, for example, the method 500 may be executed or otherwise performed by one or more processing components of another system or a combination of systems. Each block shown in FIG. 5 may further represent one or more processes, methods, or subroutines, and one or more of the blocks may include machine readable instructions stored on a non-transitory computer readable medium and executed by a processor or other type of processing circuit to perform one or more operations described herein.

At block 502, one or more of a head motion, body motion, head motion speed, user's eye gaze, displayed content, ambient light level, and comparable parameters may be detected/determined by sensors and other components on or external to the near-eye display device.

At block 504, a characteristic of the display to be adjusted may be determined. For example, a duty cycle, a persistence, a display rate, a localized brightness, a refresh rate, etc. may be adjusted based on the corresponding parameters.

At block 506, an adjustment level may be determined. For example, brightness level for the displayed content may be determined based on ambient light level.

At block 508, the determined characteristic may be adjusted dynamically based on the corresponding parameter to the determined adjustment level.

According to examples, a method of making a near-eye display device with brightness and power consumption enhancement is described herein. A system of making the near-eye display device is also described herein. A non-transitory computer-readable storage medium may have an executable stored thereon, which when executed instructs a processor to perform the methods described herein.

### Section II

### Discovery and Engagement of Virtual Reality Content Through Late-Binding of Permissions

Features of the present disclosure in this section are illustrated by way of example and not limited in the following figures, in which like numerals indicate like elements. One skilled in the art will readily recognize from the following that alternative examples of the structures and methods illustrated in the figures can be employed without departing from the principles described herein.

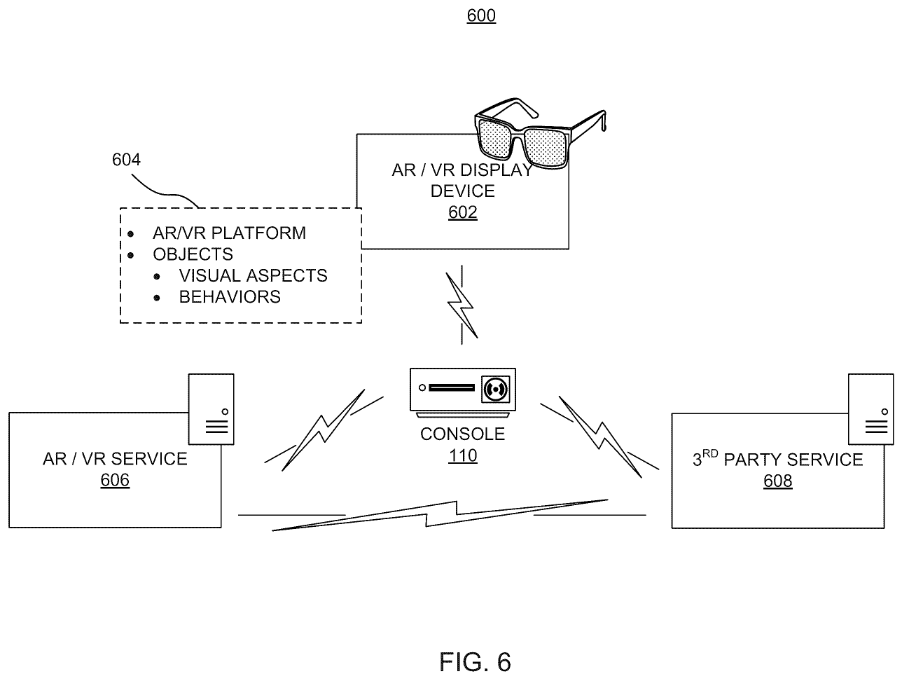

FIG. 6 illustrates major components and their interactions in an augmented reality (AR)/virtual reality (VR) system, according to examples.

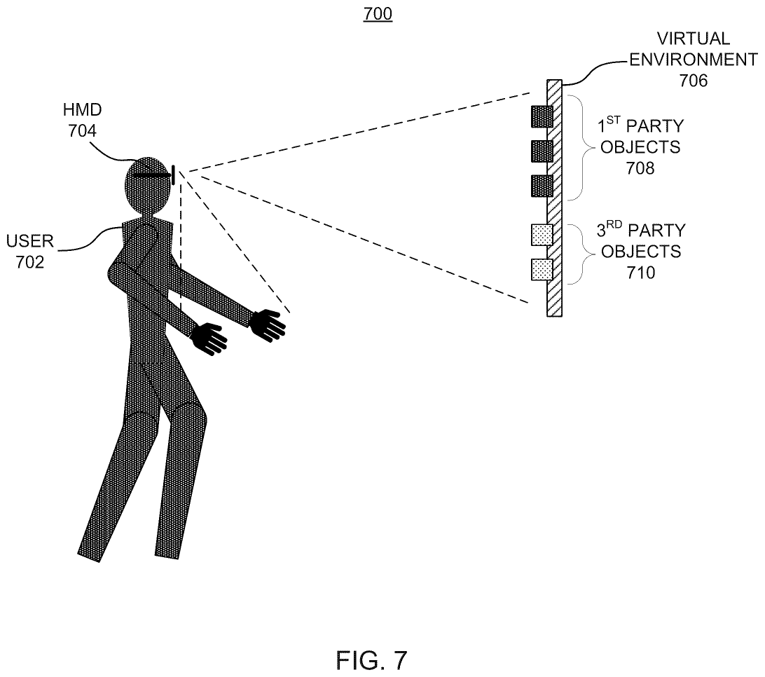

FIG. 7 illustrates presentation of different types of objects within a virtual environment, according to examples.

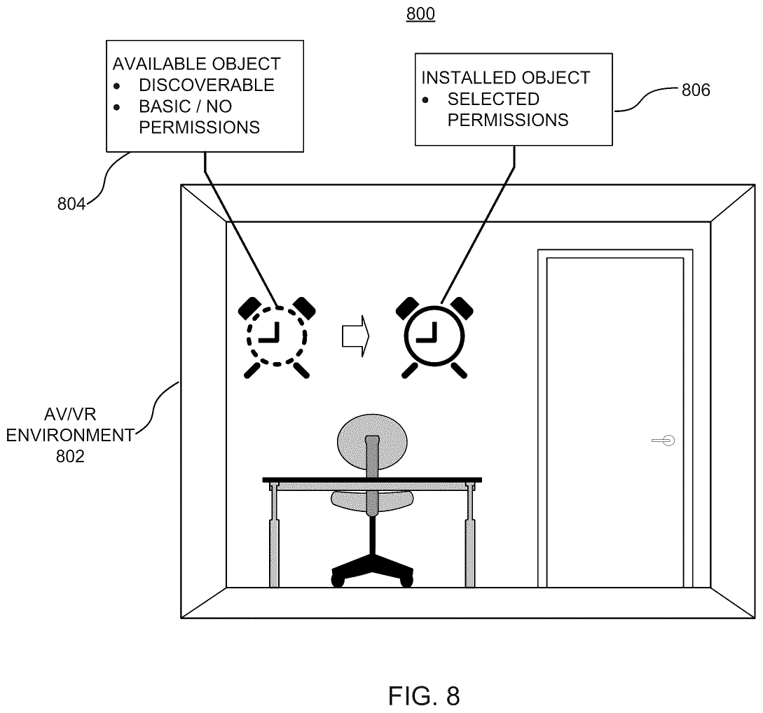

FIG. 8 illustrates transitioning of an example virtual object from an available object to an installed object in a virtual environment, according to examples.

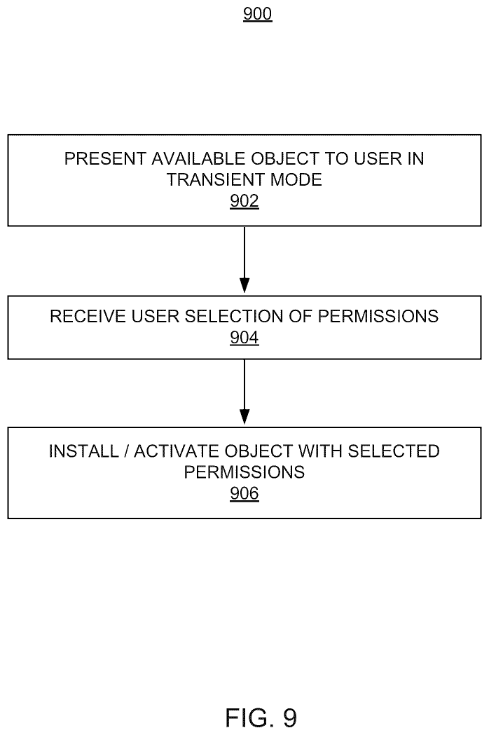

FIG. 9 illustrates a flow diagram for a method of providing an available object in a transient mode and installing upon user selection of permissions associated with the object, according to some examples.

As used herein, “radar” refers to an electromagnetic sensor for detecting, locating, tracking, and recognizing objects of various kinds at a distance by transmitting electromagnetic energy toward the objects and observing the echoes returned from the objects. A “real scene” refers to a physical environment around a user wearing augmented reality (AR)/virtual reality (VR) display device such as a near-eye display device. A “virtual scene” refers to a computer generated image of a scene and/or objects that is displayed through the near-eye display device to the user.

Augmented reality (AR)/virtual reality (VR) near-eye display devices, also referred to as smart glasses, present virtual content or virtual objects within a virtual or augmented real environment. While an augmented reality (AR)/virtual reality (VR) platform may be a closed platform, where all content is provided (or generated) by the platform provider, some platforms may be open, where third party providers may provide virtual objects. Programmatic behavior of some objects may involve access of user data, transmission of data over a network, etc., which may require user permission. However, requiring a user to select permissions each time they want to see or evaluate a virtual object may be disruptive and degrade a user experience. On the other hand, allowing objects full functionality without user permissions may risk user data.

In some examples of the present disclosure, discoverable virtual objects may be made available in a virtual environment (e.g., a three-dimensional “3D” space) for a user to bring into their display space. Some programmatic behaviors of the virtual objects such as network connectivity, access to user resources or information may require user permission. A virtual object may be presented initially in a transient mode with permissions automatically given, then moved to permanent mode with permissions selected/given by the user. In the transient mode, the virtual object may be provided with limited capabilities to allow the user to identify and experience aspects of new content prior to being presented with and required to decide on permission grants. Additionally, permission may be granted automatically for benign behaviors, for other behaviors user permission may be sought.

While some advantages and benefits of the present disclosure are apparent, other advantages and benefits may include providing virtual reality content without disruption of permission granting process while preserving a safety of user data environment. Thus, user experience in augmented reality (AR)/virtual reality (VR) systems may be improved.

FIG. 6 illustrates major components and their interactions in an augmented reality (AR)/virtual reality (VR) system, according to examples. Diagram 600 shows an augmented reality (AR)/virtual reality (VR) device 602 that executes (604) an augmented reality (AR)/virtual reality (VR) platform, which may include virtual objects with visual aspects and programmatic behaviors. The augmented reality (AR)/virtual reality (VR) device 602 may be communicatively coupled to an augmented reality (AR)/virtual reality (VR) service 606 through a console 110 as described in FIG. 1. A third party service 608 may provide virtual objects to the augmented reality (AR)/virtual reality (VR) platform via the console 110 or the augmented reality (AR)/virtual reality (VR) service 606.

In an augmented reality (AR)/virtual reality (VR) environment, users may have the ability to discover, acquire, and install new AR content, that is virtual objects, into their personal environment (e.g., an augmented world environment, a mobile application, metaverse, etc.) and onto their devices (e.g., augmented reality (AR)/virtual reality (VR) device 602). For security and privacy purposes, virtual objects with content with potentially risky programmatic behavior such as network connectivity, access to user resources or information may require explicit user permission before being activated. Content providers (e.g., third party service 608) may choose to require a user to decide and grant permissions at install-time or at runtime. In the install-time model, required permissions need to be granted by the user prior to install of the content into the user's environment (device or platform). In the runtime model, required permissions need to be granted by the user after installation (by the user) and before a potentially risky programmatic behavior is used for the first time. However, both of these approaches may block the user's ability to discover and experience aspects of the content (virtual object) that are not risky prior to the explicit permissions grant.

In some examples, to ease a user's discovery of new content (virtual objects) without being blocked by a forced decision to grant permissions, virtual objects (content) may be installed and executed within the user's environment in a protected sandbox but without the user's directed action of content acquisition. In such a state, the virtual object may be limited to executing in a transient mode (also referred to as “nascent state”) utilizing only capabilities that are not potentially risky. Runtime permissions may be utilized to require the user to grant permissions to risky capabilities prior to first use of such capabilities. By permitting autonomous acquisition and launch of content in a transient mode, an augmented reality (AR)/virtual reality (VR) environment may be automatically populated with interactive content having limited capabilities to allow the user to identify and experience aspects of new content prior to being presented with and required to decide on permission grants.

In some examples, the system described herein may be further extended to accelerate content acquisition (download) and minimize consumption (transport and storage) by dividing virtual reality content into a not risky portion and a risky portion where the portions of the content requiring risky capabilities (e.g., access to user data, access to user network, location access, etc.) are acquired and installed after the user has granted the requisite permissions.

FIG. 7 illustrates presentation of different types of objects within a virtual environment, according to examples. Diagram 700 shows a user 702 wearing a head-mounted display (HMD) device 704 and viewing a virtual environment 706 with first party objects 708 and third party objects 710 within the virtual environment 706.

A near-eye display device (head-mounted display (HMD) device 704) may present a virtual environment or a real environment augmented with virtual objects. Some of the virtual objects (first party objects 708) may be generated/provided by a augmented reality (AR)/virtual reality (VR) platform provider. Thus, such objects may be considered safe and allowed access to sensitive user information such as location, user data, network access, etc. based on previously provided user permissions and/or a user permission profile. On the other hand, some objects (third party objects 710) may be provided by a third party object provider (similar to apps on a smart phone) and may need to obtain user permission before being allowed access to sensitive user information.

Accordingly, third party objects 710 may be considered virtual objects with potentially risky programmatic behavior and may require explicit user permission before being activated. The user may decide and grant permissions at install-time or at runtime, as mentioned herein, with permissions being granted by the user prior to install of the virtual objects into the user's environment at install-time model, and the permissions being granted by the user after installation prior to first time use. In some examples, the third party objects 710 may be discoverable to the user 702, that is the user may be able to experience some (if not all) aspects of the objects without the disruption of having to grant specific permissions for the objects' installation/use.

To ensure the virtual object does not pose a risk to the user through misuse of user data or network, the virtual object may be installed in a sandbox with limited permissions allowing the user to experience various aspects of the virtual object. If the user wants to keep the virtual object, full permissions may be granted before first use. User permissions may be granted by explicit user selection (e.g., through a permissions wizard user interface), based on a user permissions profile (user may select to always allow certain permissions and explicitly select others, for example), or based on an artificial intelligence algorithm that may learn user's permission granting behavior and grant permissions on behalf of the user.

In some examples, the virtual objects may be any displayable item in the virtual or augmented reality environment. Some virtual objects may gather and/or present information (including audio, visual information). Other virtual objects may be interactive and react to user input. User input may be provided through a variety of techniques such as gesture input, touch input, eye gaze input, and others.

FIG. 8 illustrates transitioning of an example virtual object from an available object to an installed object in a virtual environment, according to examples. Diagram 800 shows an augmented reality (AR)/virtual reality (VR) environment 802 and a virtual object in discoverable mode 804 and in installed mode 806 within the augmented reality (AR)/virtual reality (VR) environment 802.

As shown in the diagram 800, the example virtual object is a clock. In some examples, a basic function of the clock may be display of time with a particular clock face. The clock virtual object may also have additional aspects such as displaying additional clock faces by downloading them from a network server, automatically setting alarms based on a user calendar by accessing the user's calendar, etc. Thus, while the basic time display aspect may be considered benign without a need to access sensitive user information, the additional aspects may involve accessing the network through the user's near-eye display device or accessing user data (user calendar). In an example scenario, the virtual object in discoverable mode 804 may be presented with the basic aspect without requiring user permissions. If the user opts to keep the clock, the virtual object may be installed in the user's system and user permissions requested when the virtual object in installed mode 806 (clock) needs to access the network to download a new clock face or access the user's calendar to set an alarm. Accordingly, the user may be allowed to experience how the clock looks and feels without permissions granting process, and grant permissions after installation (e.g., at first use).

The clock virtual object shown in diagram 800 is an illustrative example. As mentioned herein, any other type of displayable object (2D or 3D) may be presented in transient (discoverable) mode and transitioned to fully active (installed) mode upon installation. For example, the virtual object may be a calendar that accesses user information and presents calendar events based on the user information, an interactive wall display that may retrieve user's stored pictures and display them at random or upon user selection.

FIG. 9 illustrates a flow diagram for a method 900 of providing an available object in a transient mode and installing upon user selection of permissions associated with the object, according to some examples. The method 900 is provided by way of example, as there may be a variety of ways to carry out the method described herein. Although the method 900 is primarily described as being performed by the components of FIG. 6, the method 900 may be executed or otherwise performed by one or more processing components of another system or a combination of systems. Each block shown in FIG. 9 may further represent one or more processes, methods, or subroutines, and one or more of the blocks may include machine readable instructions stored on a non-transitory computer readable medium and executed by a processor or other type of processing circuit to perform one or more operations described herein.

At block 902, a virtual object may be made available to a user for installation in a virtual environment of the user in a transient mode. In the transient mode, the virtual object may be given some permissions automatically that may allow the user to experience benign aspects of the virtual object without activating potentially risky programmatic behavior such as access to user data or information, location information, network access, etc.

At block 904, user permission(s) for the virtual object may be received upon evaluation of the virtual object by the user indicating the user's intent to install and use the virtual object in their virtual environment.

At block 906, the virtual object may be installed/activated with the selected user permissions allowing all or some programmatic behavior of the virtual object. For example, a virtual object may require all its programmatic behavior to be permitted to be installed. Another virtual object may allow a selection of programmatic behavior by the user. Thus, the other virtual object may be installed based on user selected permissions. Having experienced various aspects of the virtual object, the user may make selections with knowledge and without disruption at evaluation time.

According to examples, a method of making an augmented reality (AR)/virtual reality (VR) system with discoverable objects in transient mode is described herein. A system of making the augmented reality (AR)/virtual reality (VR) system is also described herein. A non-transitory computer-readable storage medium may have an executable stored thereon, which when executed instructs a processor to perform the methods described herein.

### Section III

### Bifocal Dynamic Camera Framing for Near-Eye Display Devices

Features of the present disclosure in this section are illustrated by way of example and not limited in the following figures, in which like numerals indicate like elements. One skilled in the art will readily recognize from the following that alternative examples of the structures and methods illustrated in the figures can be employed without departing from the principles described herein.

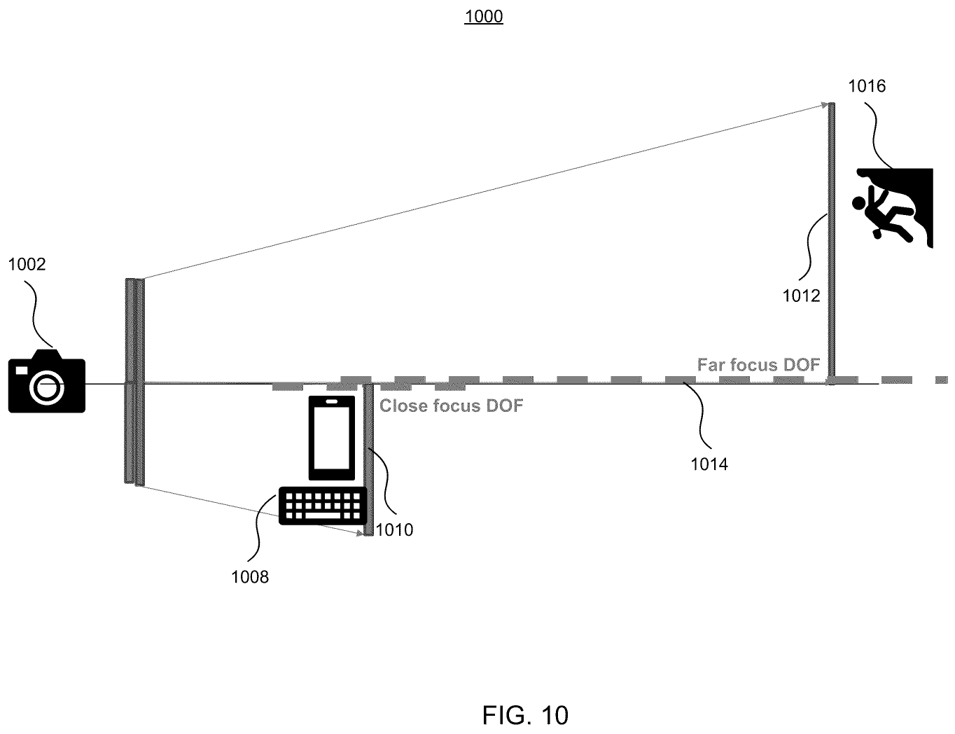

FIG. 10 illustrates a bifocal mixed reality pass-through camera's partial imaging areas focused at far and near distances, according to an example.

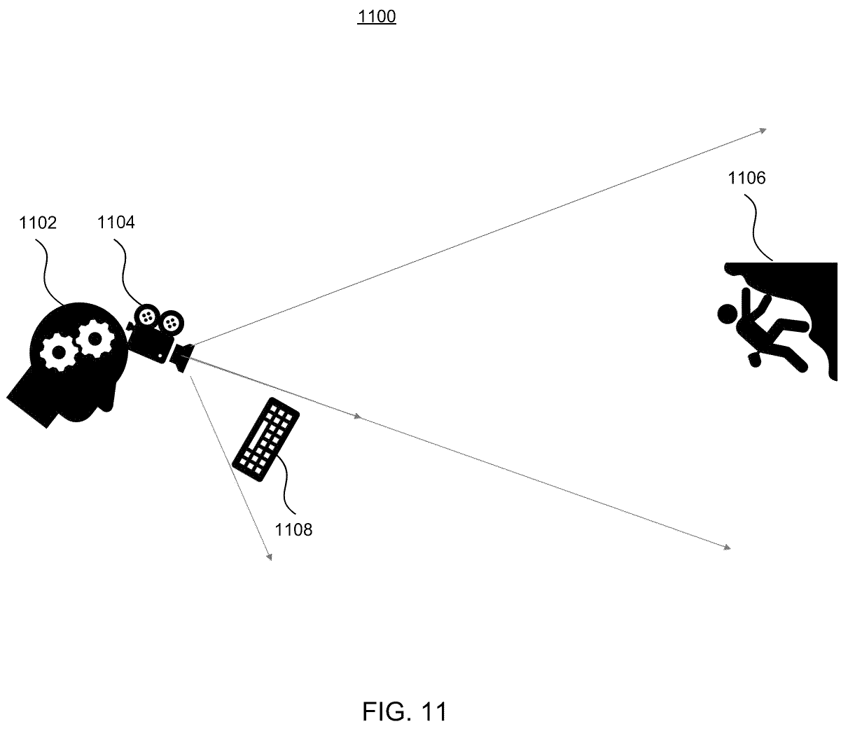

FIG. 11 illustrates how focus may be shifted in a bifocal mixed reality pass-through camera, according to examples.

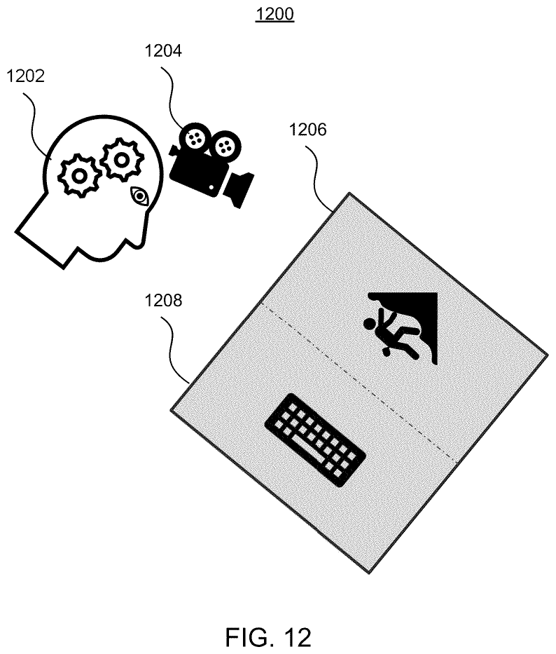

FIG. 12 illustrates presentation of different focus fields to a user through a bifocal mixed reality pass-through camera, according to an example.

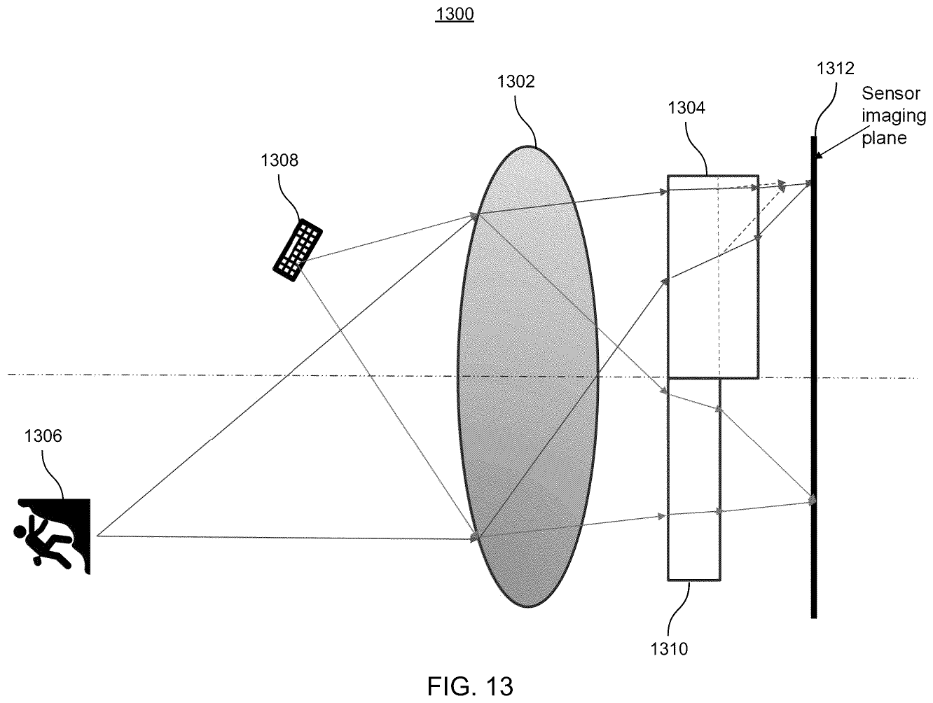

FIG. 13 illustrates a theoretical optical configuration to achieve bifocal focus fields in a mixed reality pass-through camera, according to an example.

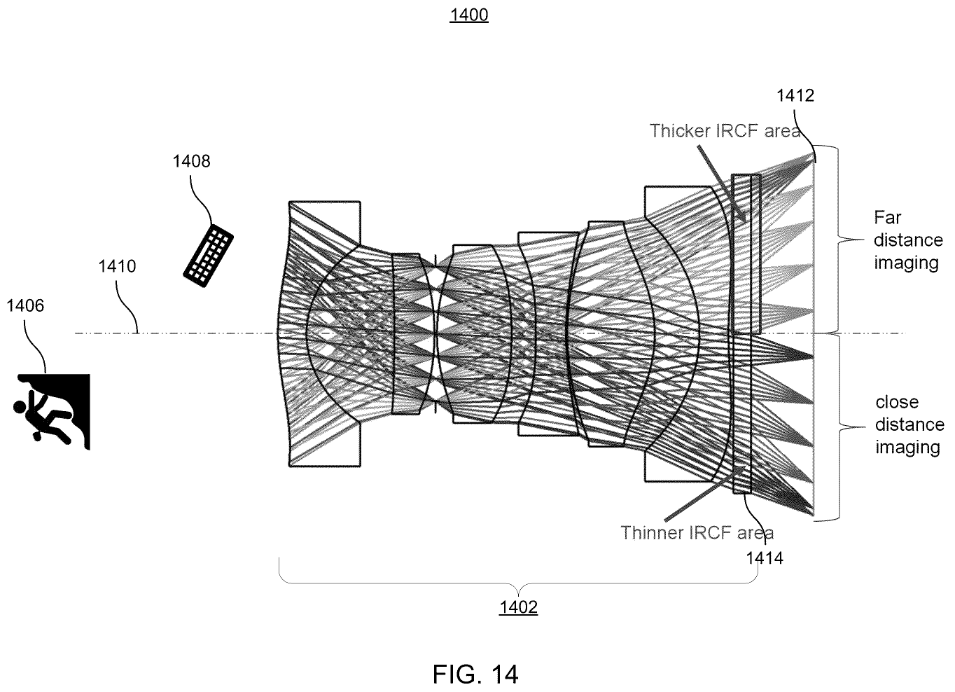

FIG. 14 illustrates an optical assembly configuration to implement the theoretical optical configuration of FIG. 6, according to an example.

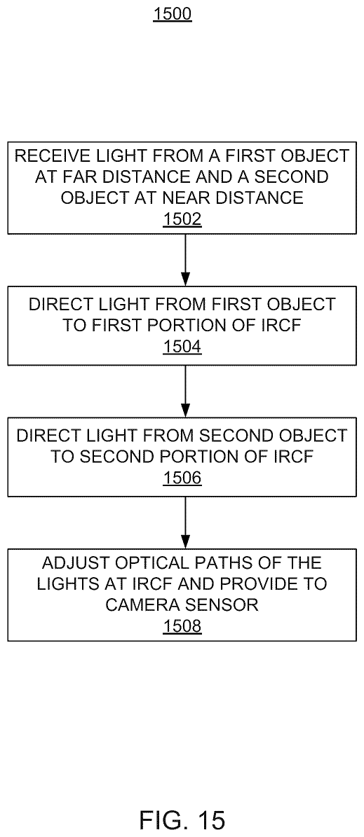

FIG. 15 illustrates a flow diagram for a method of using a bifocal mixed reality pass-through camera to present different focus fields, according to an example.

Miniature cameras are used in portable devices such as smart watches, augmented reality/virtual reality (AR/VR) glasses, smart phones, etc. To achieve optical magnification (zoom) in such devices may be difficult due to limited envelop restrictions, no moving parts preference for reliability concerns, and/or power consumption restrictions. Additional challenges in miniature camera design may include high image quality and low light performance requirements, production yield, and cost concerns. Some implementations employ two or more individual cameras with different focal lengths and switch images among the cameras to provide different optical magnifications.

The present disclosure describes a bifocal mixed reality pass-through camera to present different focus fields to a user. In some examples, a camera device may include an optical assembly with one partial imaging area focused at a far distance and another partial imaging area focused at a near distance, where the combined depth of field (DOF) covers the entire DOF of the camera device. A user wearing the camera (e.g., on a head-mounted display (HMD) device) may tilt their head to put an interested object in the user's focus field. The camera device may also include infrared cut-off filters (IRCFs), which may have different thicknesses at different locations and combine far distance imaging and near distance imaging onto the same image plane. The camera may also allow the user's eyes to gaze at the object of interest that is displayed on the display screen in front of their eyes.

While some advantages and benefits of the present disclosure are apparent, other advantages and benefits may include providing two distinct optical focus fields through a single camera without moving parts, thus higher reliability, lower power consumption, high image quality and low light performance, and/or reduced cost.

FIG. 10 illustrates a bifocal mixed reality pass-through camera's partial imaging areas focused at far and near distances, according to an example. Diagram 1000 shows a camera device 1002 with a far distance focus DOF 1004 to capture an object 1016 at the far distance and a near distance focus DOF 1006 to capture an object 1008 at the near distance.

Mixed reality (MR) pass-through cameras allow a user to see their surrounding environment, while also being presented with virtual reality content augmented on the actual environment. Such camera devices need to provide an image clear enough to recognize people in the far distance, for example, and screen text readable at close distance. Some approaches for such clarity may include using a camera sensor with more pixels to increase image resolution, using a sensor with bigger pixels, and/or lower F/# to improve low light image performance. However, fixed focus lens design cannot cover such large required depth of field with sufficiently clear image. Thus, fixed focus camera devices have a trade-off between resolution, DOF, and low light performance.

Another approach to focus change in camera devices is gaze driven autofocus pass-through camera configuration, which work with an eye tracking camera to locate which object eyes are looking at, then autofocus on that object. The autofocus technologies include voice coil motor (VCM) or varifocal lens. These approaches, however, usually consume more power for autofocus and image processing, have bigger camera package size, need to be synchronized (if two cameras are used), and have reliability/manufacturing challenges.

The far distance focus DOF 1004 and the near distance focus DOF 1006 of the camera device 1002 in diagram 1000 are fixed focus fields. As the two fixed focus fields are achieved by stationary optics (and not by motorized or electronic components), power consumption, reliability, etc. challenges are mitigated.

FIG. 11 illustrates how focus may be shifted in a bifocal mixed reality pass-through camera, according to examples. Diagram 1100 shows a camera device 1104 on a user's head 1102 with two distinct focus DOFs, far distance focus field to capture object 1106 at the far distance and near distance focus field to capture object 1108 at the near distance.

People tend to look up when looking at far distance and down when looking at near distance such as looking at a computer screen or reading. Thus, arranging the fixed focus fields of the camera device 1104 such that the far distance focus DOF is above the near distance focus DOF may allow a user to naturally switch between the two focus fields: tilt the head up for far distance, tilt the head down for near distance.

FIG. 12 illustrates presentation of different focus fields to a user through a bifocal mixed reality pass-through camera, according to an example. Diagram 1200 shows a camera device 1204 on a head 1202 of a user (for example, as part of a head-mounted display (HMD) device) with the user seeing far distance focus DOF 1206 and near distance focus DOF 1208 vertically arranged. In some examples, one of the two focus DOFs may be selected based on the user's head tilt and presented to the user's eyes.

FIG. 13 illustrates a theoretical optical configuration to achieve bifocal focus fields in a mixed reality pass-through camera, according to an example. Diagram 1300 shows an optical lens 1302 arranged to direct light from a near distance object 1308 to a thinner portion 1310 of an IRCF and light from a far distance object 1306 toward a thicker portion 1304 of the IRCF. The lights from the objects are then provided onto respective portions of the camera sensor 1312 on the same imaging plane.

In some examples, the optical lens's configuration may allow the IRCF portions with different thicknesses to increase an optical path for the object 1306 at the far distance (additional IRCF material with higher refractive index than air due to the increased thickness) such that far and near objects are imaged at the same image plane (camera sensor 1312) making their image quality both clear without further electronic processing or adjustment of positions of any of the components. In some implementations, refractive index of the IRCF may be about 1.52, and a thickness range of the IRCF may be in a range from about 0.25 mm to about 0.5 mm.

Accordingly, two objects at different distances may be viewed with same clarity by one camera with only half (or less) envelope space compared to using two separate cameras. Each image may have as good image resolution, contrast, and other image qualities compared to using two individual cameras. Furthermore, the camera does not need to have moving elements (for switching distances). Cost and complexity of a host device may also be lower by reduction of the number of cameras.

FIG. 14 illustrates an optical assembly configuration to implement the theoretical optical configuration of FIG. 13, according to an example. Diagram 1400 shows an optical assembly 1402 if a plurality of optical lenses (and other elements) aligned along their orthogonal axis 1410 and providing images of a far distance object 1406 and a near distance object 1408 onto a camera sensor 1412.

In some examples, an infrared cut-off filter (IRCF) 1414 may be present between the optical assembly 1402 and the camera sensor 1412. By selecting different thicknesses for two portions of the IRCF 1414 the far and near distance images may be provided to two portions of the camera sensor 1412. For example, an upper portion of the IRCF 1414 may be thicker compared to the lower portion. The upper portion may provide far distance image to the camera sensor 1412, and the lower portion may provide near distance image to the camera sensor 1412. The object at far distance has shorter image distance than object at near distance. By increasing the local IRCF thickness, optical path may be increased (because IRCF material has higher refractive index than air) for the object at far distance such that far and near objects may be imaged at the same image plane.

In some examples, the optical assembly 1402 may include a number of negative and/or positive optical power lenses. In practical implementations, the negative and/or optical power lenses may change a diagonal field of view (DFOV) of the camera device, provide imaging power, correct spherical and chromatic aberrations, and/or correct distortion and other remaining aberrations. The optical errors and aberrations may include two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

The optical lenses in the optical assembly may be any suitable optical lens such as concave, plano-concave, plano-convex, concave-convex, and others. The optical assembly 1402 may include a single optical element or any number of combinations of various optical elements as well as mechanical couplings to maintain relative spacing and orientation of the optical elements in the combination.

In some examples, one or more optical elements may have an optical coating, such as an anti-reflective coating, a reflective coating, a filtering coating, and/or a combination of different optical coatings. Furthermore, other optical elements such as filters, polarizers, and comparable elements may also be included in the optical assembly 1402.

FIG. 15 illustrates a flow diagram for a method of using a bifocal mixed reality pass-through camera to present different focus fields, according to an example. The method 1500 is provided by way of example, as there may be a variety of ways to carry out the method described herein. Although the method 1500 is primarily described as being performed by the components of FIG. 14, the method 1500 may be executed or otherwise performed by one or more processing components of another system or a combination of systems. Each block shown in FIG. 15 may further represent one or more processes, methods, or subroutines, and one or more of the blocks (e.g., the selection process) may include machine readable instructions stored on a non-transitory computer readable medium and executed by a processor or other type of processing circuit to perform one or more operations described herein.

At block 1502, light may be received from a first object that is at a far distance to a camera and a second object that is at a near distance to the camera. The light from the first object may be directed by an optical lens or an optical assembly toward a first portion of an IRCF that is thicker at block 1504, whereas the light from the second object may be directed by the optical lens or the optical assembly toward a second portion of the IRCF that is thinner at block 1506.

At block 1508, the portions of the IRCF with different thicknesses may adjust optical paths from the first and second objects such that the images of the objects fall onto the same imaging plane on the camera sensor. Accordingly, both objects may be captured (and displayed to a user) with same clarity, resolution, etc.

According to examples, a method of making a bifocal mixed reality pass-through camera is described herein. A system of making the bifocal mixed reality pass-through camera is also described herein. A non-transitory computer-readable storage medium may have an executable stored thereon, which when executed instructs a processor to perform the methods described herein.

### Section IV

### A Scanning System for Eye Tracking Applications Employing a Dynamic Photodiode (DPD)

Features of the present disclosure in this section are illustrated by way of example and not limited in the following figures, in which like numerals indicate like elements. One skilled in the art will readily recognize from the following that alternative examples of the structures and methods illustrated in the figures can be employed without departing from the principles described herein.

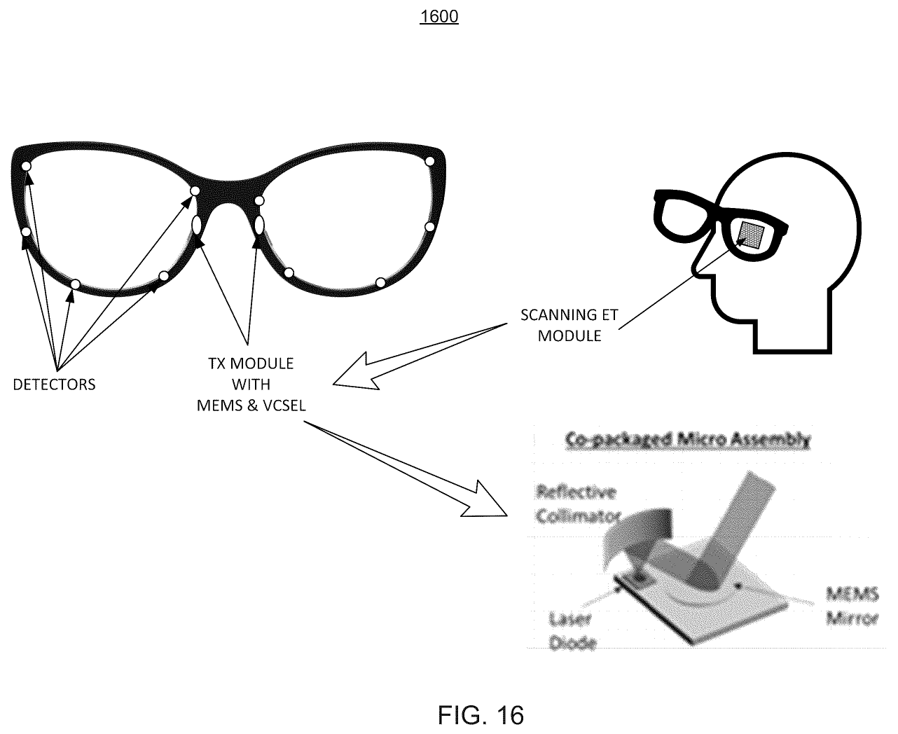

FIG. 16 illustrates an optical schematic of a time of flight based eye tracking system, according to an example.

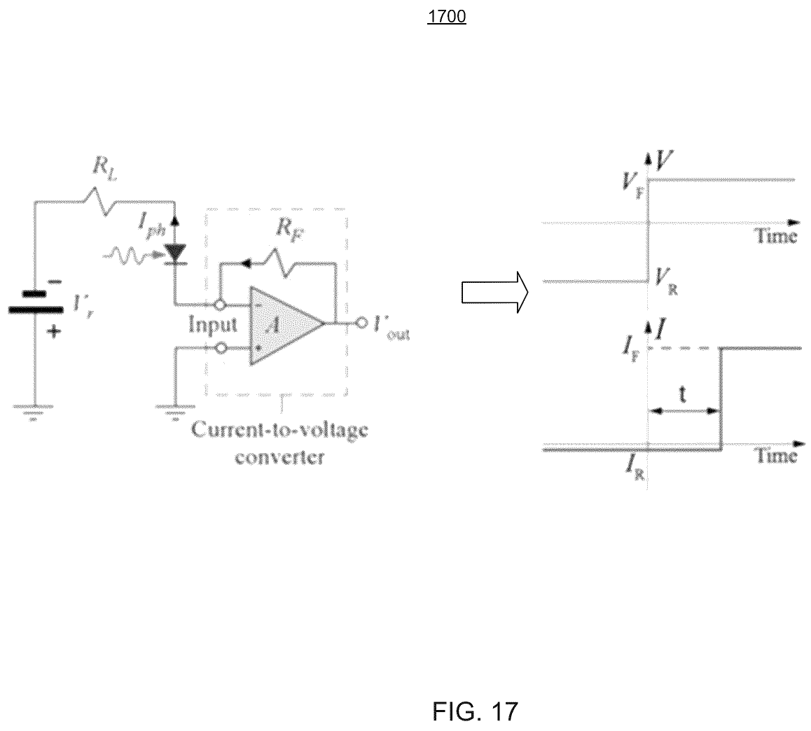

FIG. 17 illustrates a difference between conventional photodiode detection circuitry and dynamic photodiode (DPD), according to an example.

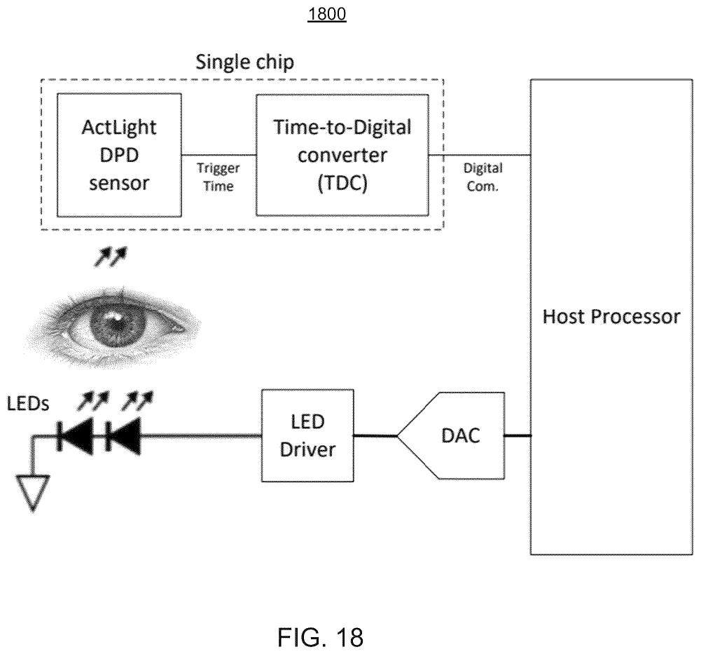

FIG. 18 is an illustration of a DPD based eye tracking system, according to an example.

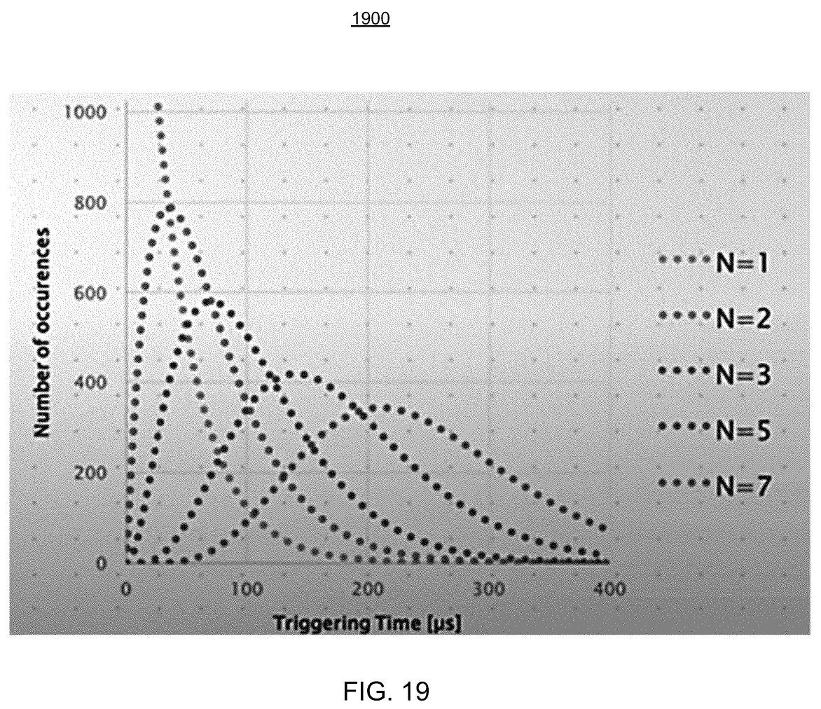

FIG. 19 illustrates a graph of single photon detection capability of the DPD, according an example.

According to some examples, a scanning system for eye tracking applications may employ a photodetector device such as a dynamic photodiode (DPD) to detect light reflections received from the eye, and to measure pupil grayscale intensity and glint information. The system may also include an LED driver or a laser driver for providing a light source driving signal. The dynamic photodiode (DPD) may be configured to convert light intensity into a time delay based on the trigger time of the DPD. The DPD may also collect the light reflections by using time-to-digital converters (TDC).

In a scanning-based eye tracking system, as illustrated in diagram 1600 of FIG. 16, usually information is gathered of pupil grayscale images and glints for detection. The detection of the grayscale intensity and glint information is traditionally realized with photodiodes (PDs) and avalanche photodiodes (APDs). However, there is big signal strength difference in high intensity reflection areas, like the secularly reflected glints, and low intensity reflection areas, like the pupil regions. Due to these large intensity differences, a lot of times there will be saturations which blur the glints, or the SNR of the pupil boundary is not enough, depending on the bias voltage and laser intensity used.

According to some examples, a scanning eye tracking system based on dynamic photodiode is described. The operational difference between conventional photodiode detection circuitry and dynamic photodiode (DPD) are shown in diagram 1700 of FIG. 17. Instead of directly getting the photo current from the PDs and sampled with ADCs, dynamic PDs (DPDs) that convert laser intensity into time delay from the firing moment of the detector may be utilized.

Diagram 1800 in FIG. 18 shows a schematic of an example eye tracking system, where the LED driver or the laser driver outputs driving signal for the light sources, and the scattering and specular reflections of the light from the eye are detected by the dynamic photodiodes, and afterwards collected by time-to-digital converters (TDC).

As shown in diagram 1900 of FIG. 19, DPDs are capable of capturing single photon events due to their very high SNR. DPD is shot-noise limited on the whole range of operation, and is tunable through its bias voltage. It is capable of getting high sensitivity at low voltage bias and requires ultra-low power consumption and ultra-low operational voltage. Meanwhile, use of DPD also enables lower production cost with smaller silicon footprint. All these features enable low power consumption and high dynamic range eye tracking for AR/VR applications.

In the foregoing descriptions, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and descriptions are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A near-eye display device, comprising:
a transparent display to present augmented reality content;
at least one sensor to detect a parameter associated with the near-eye display device; and:
a controller communicatively coupled to the display and the at least one sensor, the controller to:
determine based on the detected parameter whether the display is in a world-lock view or in a head-lock view; and
in response to determining the display is in the head-lock view, increase a duty cycle for the display, thereby increasing a brightness of the display.

2. The near-eye display device of claim 1, wherein the controller is further to:
reduce a frame rate of the display.

3. The near-eye display device of claim 1, wherein
the at least one sensor is to detect a head movement speed; and
the controller is further to adjust at least one of a persistence or a frame rate based on the detected head movement speed.

4. The near-eye display device of claim 3, wherein
the at least one sensor is to detect the head movement speed being reduced; and
the controller is further to increase the persistence or reduce the frame rate based on the reduced head movement speed.

5. The near-eye display device of claim 1, wherein
the at least one sensor is to detect an ambient light level for the near-eye display device; and
the controller is further to adjust a brightness for at least a portion of the display based on the detected ambient light level.

6. The near-eye display device of claim 1, wherein
the at least one sensor is to detect a fovea region of a wearer of the near-eye display device; and
the controller is further to reduce a brightness for periphery of the detected fovea region.

7. The near-eye display device of claim 1, wherein
the at least one sensor is to detect a gaze of a wearer of the near-eye display device; and
the controller is further to:
determine whether the wearer is looking at an environment of the near-eye display device or at the presented augmented reality content; and
adjust a brightness of the presented augmented reality content based on whether the wearer is looking at the environment of the near-eye display device or at the presented augmented reality content.

8. The near-eye display device of claim 1, wherein
the at least one sensor is to detect a gaze of a wearer of the near-eye display device; and
the controller is further to:
determine whether the wearer is looking at an object in the presented augmented reality content; and
adjust a brightness of peripheral content in the presented augmented reality content based on object the wearer is looking at.

9. The near-eye display device of claim 1, wherein
the at least one sensor is to detect whether a wearer of the near-eye display device is moving; and
the controller is further to adjust at least one of a world-locked rendering target or a refresh rate based on whether the wearer of the near-eye display device is moving.

10. The near-eye display device of claim 1, wherein the controller is further to:
determine whether a wearer of the near-eye display device is viewing the presented augmented reality content; and
adjust at least one of a brightness, a duty cycle, or a frame rate of the presented augmented reality content based on the determination.

11. The near-eye display device of claim 10, wherein the controller is to determine whether the wearer of the near-eye display device is viewing the presented augmented reality content based on at least one of an external device usage, a type of the presented augmented reality content, or a wearer action.

12. A method, comprising:
displaying, through a transparent display of a near-eye display device, augmented reality content to a user;
detecting, through at least one sensor, a parameter associated with the near-eye display device;
determining based on the detected parameter whether the display is in a world-lock view or in a head-lock view; and
in response to determining the display is in the head-lock view, increasing a duty cycle or reduce a frame rate for the display.

13. The method of claim 12, further comprising:
detecting, through the at least one sensor, a head movement speed of the user being reduced; and
increasing a persistence or reducing a frame rate of the display based on the reduced head movement speed.

14. The method of claim 12, further comprising:
detecting, through the at least one sensor, an ambient light level for the near-eye display device; and
adjusting a brightness for at least a portion of the display based on the detected ambient light level.

15. The method of claim 12, further comprising:
detecting, through the at least one sensor, a fovea region of user; and
reducing a brightness for periphery of the detected fovea region.

16. The method of claim 12, further comprising:
detecting, through the at least one sensor, a gaze of the user;
determining whether the user is looking at an environment of the near-eye display device or at the presented augmented reality content; and
adjusting a brightness of the presented augmented reality content based on whether the user is looking at the environment of the near-eye display device or at the presented augmented reality content.

17. The method of claim 12, further comprising:
detecting, through the at least one sensor, whether the user is moving; and
adjusting at least one of a world-locked rendering target or a refresh rate of the display based on whether the user is moving.

18. A non-transitory computer-readable storage medium having an executable stored thereon, which when executed instructs a processor to:
display, through a transparent display of a near-eye display device, augmented reality content to a user;
detect, through at least one sensor, a parameter associated with the near-eye display device;
determine based on the detected parameter whether the display is in a world-lock view or in a head-lock view; and
in response to determining the display is in the head-lock view, increase a duty cycle or reduce a frame rate for the display.

19. The non-transitory computer-readable storage medium of claim 18, wherein the executable further instructs the processor to:
determine whether the user is viewing the presented augmented reality content; and
adjust at least one of a brightness, a duty cycle, or a frame rate of the presented augmented reality content based on the determination.

20. The non-transitory computer-readable storage medium of claim 19, wherein the executable further instructs the processor to:
determine whether the user is viewing the presented augmented reality content based on at least one of an external device usage, a type of the presented augmented reality content, or a user action.
